(19) United States
(12) Patent Application Publication
(10) Pub. No.: US 2024/0286613 A1
(43) Pub. Date: Aug. 29, 2024

(54) DRIVER MONITORING DEVICE, DRIVER MONITORING METHOD, AND NON-TRANSITORY RECORDING MEDIUM

(71) Applicant: TOYOTA JIDOSHA KABUSHIKI KAISHA, Toyota-shi Aichi-ken (JP)

(72) Inventors: Jiro Fujino, Nerima-ku Tokyo-to (JP); Kenichiroh Hara, Yokohama-shi Kanagawa-ken (JP)

(73) Assignee: TOYOTA JIDOSHA KABUSHIKI KAISHA, Toyota-shi Aichi-ken (JP)

(21) Appl. No.: 18/582,994

(22) Filed: Feb. 21, 2024

(30) Foreign Application Priority Data
Feb. 28, 2023 (JP) 2023-029606

(51) Int. Cl. B60W 30/16; B60W 50/10; B60W 50/14; G06V 20/58; G06V 20/59; G06V 40/16; G08G 1/16

(52) U.S. Cl. CPC B60W 30/16; B60W 50/10; B60W 50/14; G06V 20/58; G06V 20/597; G06V 40/175; G08G 1/166; B60W 2540/22; B60W 2540/221; B60W 2554/802

(57) ABSTRACT

The driver monitoring device includes an expression judgment part configured to judge an expression of a driver of a vehicle from an image generated by an imaging device capturing a face of the driver; and a processing part configured to calculate a frequency by which it is judged the expression of the driver is an expression of surprise and perform a predetermined processing for enhancing a safety of the driver when the frequency is greater than or equal to a threshold value.

### CROSS-REFERENCE TO RELATED APPLICATIONS

This application claims priority to Japanese Patent Application No. 2023-029606, filed on Feb. 28, 2023, which is incorporated herein by reference.

### FIELD

The present disclosure relates to a driver monitoring device, a driver monitoring method, and a non-transitory recording medium.

### BACKGROUND

PTL 1 describes using at least one of imaging data obtained by capturing a face of a driver before starting driving and speech sound data representing content of speech of the driver to detect an involuntary reaction of the driver and detecting a degree of hazard of driving by the driver based on the result of detection.

PTL 2 describes judging a cognitive control ability of a driver based on a frequency of operation of vehicle mounted equipment when an amount of operation of a driving apparatus exceeds a predetermined threshold value and a range of line-of-sight scan density becoming narrower if a degree of load of the driver is high and a cognitive control ability of the driver is low.

PTL 3 describes calculating a number of hazard points based on four judgment items relating to a driving state of a driver and prompting voluntary return of a driver's license of the driver and notifying a related party outside the vehicle of a drop in the cognitive functions of the driver if the number of hazard points exceeds a threshold value.

PTL 4 describes identifying a degree of cognitive ability of a driver with respect to a potentially colliding vehicle based on bio information of the driver and outputting cognitive assistance regarding the approach of a potentially colliding vehicle if the degree of cognitive ability falls below a predetermined level.

### CITATION LIST

### Patent Literature

[PTL 1] Japanese Unexamined Patent Publication No. 2020-030552

[PTL 2] Japanese Unexamined Patent Publication No. 2009-237776

[PTL 3] Japanese Unexamined Patent Publication No. 2021-149377

[PTL 4] Japanese Unexamined Patent Publication No. 2010-083205

### SUMMARY

### Technical Problem

There is room for improvement in the technique for precisely judging the cognitive functions of a driver and enhancing the safety of a driver liable to be declining in cognitive functions.

Therefore, in view of this problem, an object of the present disclosure is to enhance the safety of a driver whose cognitive functions are liable to be declining.

### Solution to Problem

The summary of the present disclosure is as follows.
(1) A driver monitoring device comprising a processor configured to: judge an expression of a driver of a vehicle from an image generated by an imaging device capturing a face of the driver; calculate a frequency by which it is judged the expression of the driver is an expression of surprise; and perform a predetermined processing for enhancing a safety of the driver when the frequency is greater than or equal to a threshold value.
(2) The driver monitoring device described in above (1), wherein the processor is configured to set the threshold value based on past data of the frequency.
(3) The driver monitoring device described in above (1) or (2), wherein the processor is configured to detect an event showing unsuitable driving by the driver, and the processor is configured to reduce the threshold value or increase a weight to the frequency due to it being judged that the expression of the driver is an expression of surprise when calculating the frequency if it is judged that the expression of the driver is an expression of surprise and the event is detected.
(4) The driver monitoring device described in above (3), wherein the processor is configured to detect a hazardous driving scene as the event based on surrounding environment information of the vehicle.
(5) The driver monitoring device described in above (4), wherein the hazardous driving scene includes a scene in which a distance between the vehicle and a moving body around the vehicle is less than or equal to a predetermined distance.
(6) The driver monitoring device described in any one of above (3) to (5), wherein the processor is configured to detect a sudden operation by the driver as the event based on information on operation of the vehicle by the driver.
(7) The driver monitoring device described in any one of above (3) to (6), wherein the processor is configured to perform another processing with a higher strength of warning than the predetermined processing if it is judged that the expression of the driver is an expression of surprise and the frequency by which the event is detected has reached a predetermined value.
(8) The driver monitoring device described in any one of above (1) to (7), wherein the processor is configured to issue a warning to the driver as the predetermined processing.
(9) The driver monitoring device described in any one of above (1) to (8), wherein the processor is configured to issue a warning to a person other than the driver as the predetermined processing.
(10) The driver monitoring device described in any one of above (1) to (9), wherein the processor is configured to ease a condition for activation of a driver assistance operation in a driver assistance function mounted in the vehicle as the predetermined processing.
(11) The driver monitoring device described in any one of above (1) to (10), wherein the processor is configured to fix to a maximum value a set vehicle-to-vehicle distance when adaptive cruise control is actuated in the vehicle as the predetermined processing.
(12) A driver monitoring method performed by a computer, comprising: judging an expression of a driver of a vehicle from an image generated by an imaging device capturing a face of the driver; and calculating a frequency by which it is judged the expression of the driver is an expression of surprise and performing a predetermined processing for enhancing a safety of the driver when the frequency is greater than or equal to a predetermined threshold value.
(13) A non-transitory recording medium having recorded thereon a computer program, the computer program causing a computer to: judge an expression of a driver of a vehicle from an image generated by an imaging device capturing a face of the driver; and calculate a frequency by which it is judged the expression of the driver is an expression of surprise and perform a predetermined processing for enhancing a safety of the driver when the frequency is greater than or equal to a predetermined threshold value.

According to the present disclosure, it is possible to enhance the safety of a driver whose cognitive functions are liable to be declining.

### BRIEF DESCRIPTION OF DRAWINGS

FIG. 1 is a schematic view of the configuration of a vehicle control system including a driver monitoring device according to a first embodiment of the present disclosure.

FIG. 2 is a view schematically showing an inside of a vehicle at which an imaging device is provided.

FIG. 3 is a functional block diagram of a processor of an ECU in the first embodiment.

FIG. 4 is a flow chart showing a control routine of driver monitoring processing in the first embodiment of the present disclosure.

FIG. 5 is a functional block diagram of a processor of an ECU in a second embodiment.

FIG. 6 is a flow chart showing a control routine of driver monitoring processing in the second embodiment of the present disclosure.

### DESCRIPTION OF EMBODIMENTS

Below, referring to the drawings, embodiments of the present disclosure will be explained in detail. Note that, in the following explanation, similar component elements are assigned the same reference notations.

### First Embodiment

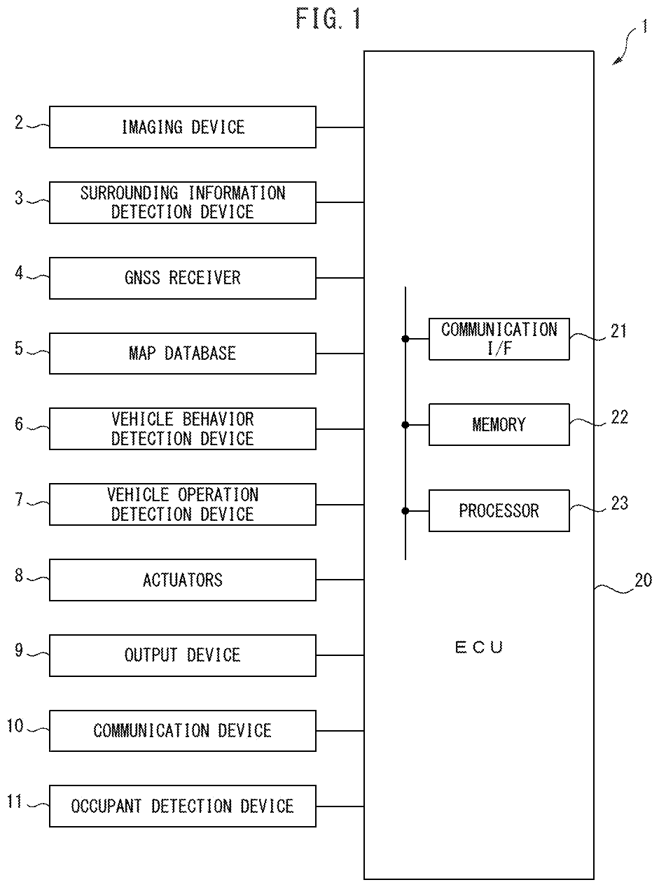

Below, referring to FIG. 1 to FIG. 4, a first embodiment of the present disclosure will be explained. FIG. 1 is a schematic view of the configuration of a vehicle control system 1 including a driver monitoring device according to the first embodiment of the present disclosure. The vehicle control system 1 is mounted in a vehicle and performs various types of control of the vehicle.

As shown in FIG. 1, the vehicle control system 1 is provided with an imaging device 2, a surrounding information detection device 3, a GNSS (global navigation satellite system) receiver 4, a map database 5, a vehicle behavior detection device 6, a vehicle operation detection device 7, actuators 8, an output device 9, a communication device 10, an occupant detection device 11, and an electronic control unit (ECU) 20. The imaging device 2, the surrounding information detection device 3, the GNSS receiver 4, the map database 5, the vehicle behavior detection device 6, the vehicle operation detection device 7, the actuators 8, the output device 9, the communication device 10, and the occupant detection device 11 are electrically connected to the ECU 20 through an internal vehicle network compliant with a CAN (controller area network) or other standard.

The imaging device 2 captures a face of the driver of the vehicle and generates an image representing the face of the driver. The output of the imaging device 2, i.e., the image generated by the imaging device 2, is transmitted to the ECU 20. Note that the imaging device 2 is also referred to as a driver monitor camera. A specific example of the configuration of the imaging device 2 will be described below.

The imaging device 2 has a camera and a projector. The camera is comprised of a lens and an imaging element and is for example a CMOS (complementary metal oxide semiconductor) camera or a CCD (charge coupled device) camera. The projector is an LED (light emitting diode) and for example includes two near infrared LEDs arranged at the two sides of the camera. By firing near infrared light at a driver, it is possible to capture an image of the driver without irritating the driver even at night time and other times of low illumination. Further, a bandpass filter for removing light of a wavelength component other than the near infrared may be provided at the inside of the camera, while a visible light cut filter for removing light of a red wavelength component emitted from a near infrared LED may be provided at the front surface of the projector.

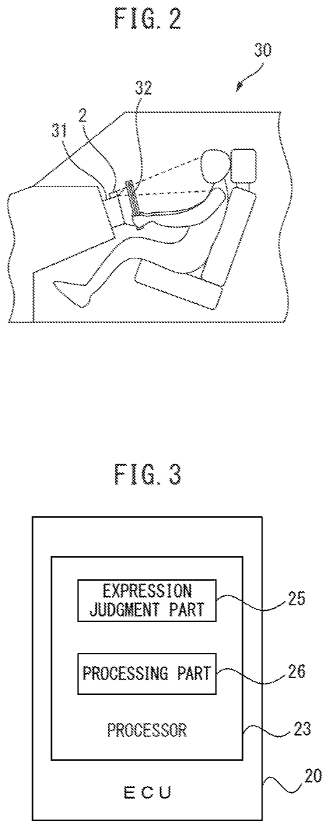

FIG. 2 is a view schematically showing an inside of a vehicle 30 at which the imaging device 2 is provided. The imaging device 2 is provided at the inside of the passenger compartment so as to capture a face of the driver of the vehicle 30. For example, as shown in FIG. 2, the imaging device 2 is provided at the top part of a steering column 31 of the vehicle 30. FIG. 2 shows the range of projection of the imaging device 2 by broken lines. Note that, the imaging device 2 may be provided at a steering wheel 32, a room mirror, an instrument panel, an instrumentation hood, etc., of the vehicle 30. Further, the vehicle control system 1 may be provided with a plurality of imaging devices.

The surrounding information detection device 3 acquires data (images, point cloud data, etc.,) around the vehicle 30 and detects peripheral information (for example, peripheral vehicles, lanes, pedestrians, bicycles, traffic lights, signs, etc.,) of the vehicle 30. For example, the surrounding information detection device 3 includes a camera (monocular camera or stereo camera), a millimeter-wave radar, a LIDAR (Laser Imaging Detection And Ranging) or an ultrasonic sensor (sonar), or any combination thereof. Note that the surrounding information detection device 3 may further include an illuminance sensor, a rain sensor, etc. The output of the surrounding information detection device 3, i.e., the peripheral information of the vehicle 30 detected by the peripheral information detection device 3 is sent to the ECU 20.

The GNSS receiver 4 detects the present position of the vehicle 30 (for example, the latitude and longitude of the vehicle 30) based on positioning information obtained from a plurality of (for example, three or more) positioning satellites. Specifically, the GNSS receiver 4 captures a plurality of positioning satellites and receives radio waves transmitted from the positioning satellites. Then, the GNSS receiver 4 calculates the distance to each of the positioning satellites based on the difference between the transmission time and the reception time of the radio wave, and detects the present position of the vehicle 30 based on the distance to the positioning satellite and the position (orbit information) of the positioning satellite. The output of the GNSS receiver 4, i.e., the present position of the vehicle 30 detected by the GNSS receiver 4, is sent to the ECU 20. The GPS (Global Positioning System) receiver is an example of the GNSS receiver.

The map database 5 stores map information. The ECU 20 acquires map information from the map database 5. Note that the map database may be provided at the outside of the vehicle 30 (for example, a server etc.), and the ECU 20 may acquire map information from the outside of the vehicle 30.

The vehicle behavior detection device 6 detects behavior information of the vehicle 30. The vehicle behavior detection device 6 includes, for example, a vehicle speed sensor for detecting the speed of the vehicle 30, a yaw rate sensor for detecting a yaw rate of the vehicle 30, etc. The output of the vehicle behavior detection device 6, that is, the behavior information of the vehicle detected by the vehicle behavior detection device 6, is sent to the ECU 20.

The vehicle operation detection device 7 detects information on operation of the vehicle 30 by the driver. The vehicle operation detection device 7 includes, for example, an accelerator position sensor for detecting an accelerator opening degree of the vehicle 30, a brake position sensor for detecting the position of a brake pedal of the vehicle 30, a steering angle sensor for detecting an amount of steering of the vehicle 30, etc. The output of the vehicle operation detection device 7, that is, operation information of the vehicle 30 detected by the vehicle operation detection device 7, is sent to the ECU 20.

The actuators 8 enable the vehicle 30 to operate. For example, the actuators 8 include drive devices for acceleration of the vehicle 30 (for example, at least one of an internal combustion engine and an electric motor), a brake actuator for braking (decelerating) the vehicle 30, a steering actuator for steering the vehicle 30, etc. The ECU 20 controls the actuators 8 to control the behavior of the vehicle 30.

The output device 9 outputs information to an occupant of the vehicle 30 (for example, the driver). The output device 9 includes a display, a speaker, a light source, a vibration unit, etc. The output of the ECU 20 is notified through the output device 9 to an occupant of the vehicle 30. Note that, the output device 9 may be an input/output device (for example, a human machine interface (HMI)) further having an input part to which information is input by an occupant of the vehicle 30 (for example, a touch panel, operating buttons, operating switches, a microphone, etc.)

The communication device 10 can communicate with the outside of the vehicle 30 and enables communication between the vehicle 30 and the outside of the vehicle 30. For example, the communication device 10 includes a wide area communicator enabling wide area communication between the vehicle 30 and the outside of the vehicle 30 (for example, a server) through a communication network such as a carrier network and the Internet, a vehicle-to-vehicle communicator enabling vehicle-to-vehicle communication between the vehicle 30 and a surrounding vehicle using a predetermined frequency band, and a road-to-vehicle communicator enabling road-to-vehicle communication using a predetermined frequency band. The ECU 20 communicates with the outside of the vehicle 30 through the communication device 10.

The occupant detection device 11 detects an occupant of the vehicle 30 other than the driver. The occupant detection device 11 includes an internal vehicle camera capturing the inside of the passenger compartment, a seatbelt sensor or a seating sensor provided at a front passenger seat or back seat, etc. The output of the occupant detection device 11, that is, the result of detection of an occupant other than the driver, is sent to the ECU 20.

The ECU 20 performs various controls of the vehicle. As shown in FIG. 1, the ECU 20 includes a communication interface 21, a memory 22 and a processor 23. The communication interface 21 and the memory 22 are connected to the processor 23 via signal lines. In the present embodiment, one ECU 20 is provided, but a plurality of ECUs may be provided for each function. The ECU 20 is one example of a driver monitoring device.

The communication interface 21 has an interface circuitry for connecting the ECU 20 to the in-vehicle networking. The ECU 20 is connected to other in-vehicle devices via the communication interface 21.

The memory 22 includes, for example, a volatile semiconductor memory and a non-volatile semiconductor memory. The memory 22 stores programs, data, etc., used when various kinds of processing are executed by the processor 23.

The processor 23 includes one or more CPU (Central Processing Unit) and its peripheral circuitry. Note that the processor 23 may further include an arithmetic circuit such as a logical arithmetic unit or a numerical arithmetic unit.

FIG. 3 is a functional block diagram of a processor 23 of the ECU 20 in the first embodiment. In the present embodiment, the processor 23 has an expression judgment part 25 and a processing part 26. The expression judgment part 25 and the processing part 26 are function modules realized by a computer program stored in the memory 22 of the ECU 20 being run by the processor 23 of the ECU 20. Note that, these function modules may respectively be realized by dedicated processing circuits provided at the processor 23.

The expression judgment part 25 judges an expression of the driver from an image generated by the imaging device 2 capturing the face of the driver of the vehicle 30 (below, referred to as the “facial image of the driver”). For example, the expression judgment part 25 judges the expression of the driver by inputting data of the facial image to a classifier trained in advance so as to output the type of expression from the facial image of the driver. In the training of this classifier, as teacher data, for example, images tagged with one expression among six expressions (anger, disgust, sorrow, contempt, surprise, and fear) using a technique of expression analysis based on a Facial Action Coding System (FACS) are used. As a specific example of a classifier, a neural network (for example, a convolutional neural network (CNN) etc.), a support vector machine, a random forest, or other machine learning model may be mentioned. Note that, the expression judgment part 25 may judge the expression of the driver using a technique of image recognition other than machine learning such as pattern matching.

A driver displays various expressions in accordance with the situation in the surroundings of a vehicle, etc., while driving. As a result of recent research, it was learned that among mildly cognitively impaired drivers declining in cognitive functions, compared with healthy drivers with no problems in cognitive functions, the ratio of the expression of surprise being displayed during driving becomes higher. For this reason, if the frequency of a driver displaying an expression of surprise during driving is high, a decline in the cognitive functions of the driver is suspected.

Therefore, in the present embodiment, the processing part 26 calculates the frequency by which it is judged that the expression of the driver is an expression of surprise, and performs a predetermined processing for enhancing the safety of the driver, if the frequency is greater than or equal to a predetermined threshold value. By doing this, it is possible to enhance the safety of a driver liable to be declining in cognitive functions.

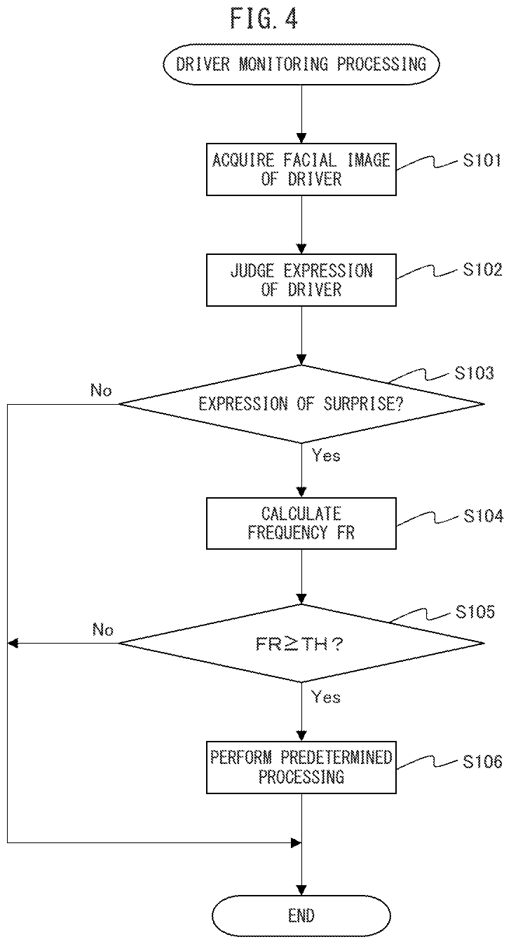

Below, referring to FIG. 4, the control explained above will be explained in detail. FIG. 4 is a flow chart showing a control routine of driver monitoring processing in the first embodiment of the present disclosure. This control routine is performed repeatedly at predetermined intervals by the processor 23 of the ECU 20 having the expression judgment part 25 and the processing part 26.

First, at step S101, the expression judgment part 25 acquires a facial image of the driver. The facial image of the driver is repeatedly generated by the imaging device 2 at predetermined capture intervals (for example, 1/30 second to 1/10 second). The expression judgment part 25 acquires a facial image of the driver from the imaging device 2. Next, at step S102, the expression judgment part 25 judges the expression of the driver based on the facial image of the driver.

Next, at step S103, the processing part 26 judges whether the expression judged by the expression judgment part 25 is an expression of surprise. If the expression judged by the expression judgment part 25 is judged to not be an expression of surprise, the present control routine ends. On the other hand, if the expression judged by the expression judgment part 25 is judged to be an expression of surprise, the present control routine proceeds to step S104.

At step S104, the processing part 26 calculates a frequency FR by which it is judged that the expression of the driver is an expression of surprise. The frequency FR is calculated as, for example, the number of times it is judged that the expression of the driver is an expression of surprise during a predetermined calculation time period. Note that, the frequency FR may be calculated as the number of times it is judged that the expression of the driver is an expression of surprise over a predetermined running distance. In this case, the running distance of the vehicle 30 is calculated based on for example the output of a speed sensor of the vehicle behavior detection device 6 etc.

Next, at step S105, the processing part 26 judges whether the frequency FR is greater than or equal to a predetermined threshold value TH. The threshold value TH is, for example, a predetermined fixed value. Note that, the threshold value TH may be set for each driver in accordance with driver information registered in advance (for example, age, gender, etc.)

For example, if the threshold value TH is 10 times/hour, when the number of times it is judged that the expression of the driver is an expression of surprise during 1 hour reaches 10 times, it is judged that the frequency FR is greater than or equal to the threshold value TH. In another example, if the threshold value TH is 5 times/10 km, when the number of times it is judged that the expression of the driver is an expression of surprise until the vehicle 30 runs 10 km reaches 5 times, it is judged that the frequency FR is greater than or equal to the threshold value TH.

If at step S105 it is judged that the frequency FR is less than the threshold value TH, the present control routine ends. On the other hand, if at step S105 it is judged that the frequency FR is greater than or equal to the threshold value TH, the present control routine proceeds to step S106.

At step S106, the processing part 26 judges that the cognitive functions of the driver have been declining and performs a predetermined processing for enhancing the safety of the driver. The processing part 26 for example performs the following processing for assisting safety. As a first processing for assisting safety, the processing part 26 issues the driver a warning. In this case, the processing part 26 issues a visual, audio, or tactile warning to the driver through the output device 9. An example of a visual warning is a warning message (for example, a message such as “cognitive functions declining, so be careful driving”) or a warning image shown on the display of the output device 9, a warning light emitted from the light source of the output device 9, etc. An example of an audio warning is a warning message or a warning sound etc. output from the speaker of the output device 9. An example of a tactile warning is vibration output from the vibration unit of the output device 9 (for example, vibration of steering wheel 32) etc. Note that, the processing part 26 may send two or more types of warnings (for example, a visual warning and an audio warning) to the driver.

Even if a warning were issued to a driver in the above way, the driver might be unwilling to accept the evaluation of the decline of cognitive functions. For this reason, as a second processing for assisting safety, the processing part 26 issues a warning to a person other than the driver. By doing this, it is possible to enhance the safety of a driver liable to be declining in cognitive functions by assistance of a person other than the driver. If a warning is issued to a person outside the vehicle 30 (for example, a family member of the driver, a driver of a surrounding vehicle, a doctor, a police officer, etc.), the processing part 26 sends a warning signal indicating that the cognitive functions of the driver of the vehicle 30 are declining to the outside of the vehicle 30 (a mobile terminal, a server, a surrounding vehicle, etc.) through the communication device 10. Further, if an occupant other than the driver is detected by the occupant detection device 11, the processing part 26 may issue a visual warning to the occupant other than the driver. By issuing a visual warning, it is possible to notify an occupant other than the driver of a decline in the cognitive functions of the driver without the driver noticing. In this case, for example, the processing part 26 displays a warning message showing that the cognitive functions of the driver of the vehicle 30 are declining on a display provided in front of an occupant other than the driver.

Further, if the cognitive functions of the driver decline, it is desirable to assist driving by the driver by vehicle control. For this reason, as a third processing for assisting safety, the processing part 26 cases the condition for activation of the driver assistance operation in the driver assistance function mounted in the vehicle 30. That is, the processing part 26 makes it easier for the driver assistance operation in the driver assistance function mounted in the vehicle 30 to be performed. For example, if a driver assistance operation (for example a warning or braking control) in pre-crash safety (PCS) is performed when the time to collision (TTC) becomes less than or equal to a predetermined value, the processing part 26 lengthens the predetermined value. Further, the conditions for activation of driver assistance operations in the driver assistance functions such as proactive driving assist (PDA) or lane departure alert (LDA) may be cased.

Further, as a fourth processing for assisting safety, the processing part 26 fixes to a maximum value a set vehicle-to-vehicle distance when adaptive cruise control (ACC) is actuated as a driver assistance function. For example, if the set vehicle-to-vehicle distance in ACC can be set to three stages (short distance, medium distance, and long distance), the processing part 26 fixes the set vehicle-to-vehicle distance to the long distance. By doing this, it becomes easy to deal with unforeseen motion of a preceding vehicle, and thus even if the cognitive functions of the driver are declining, it is possible to enhance the safety of the driver when the ACC is actuated.

Note that, the processing part 26 can perform one or any combination of the first to fourth processings for assisting safety if it is judged that the frequency FR is greater than or equal to the threshold value TH. Further, the processing part 26 may perform a processing other than the first to fourth processings for assisting safety, so long as the processing is for enhancing the safety of the driver. After step S106, the present control routine ends.

Note that, the processing part 26 may perform a predetermined processing for enhancing the safety of a driver if the frequency by which it is judged the expression of the driver is an expression of surprise is greater than or equal to a predetermined threshold value over a predetermined time period or a predetermined running distance. In this case, for example, if the threshold value is 10 times/hour, the processing part 26 performs a predetermined processing when the state where the number of times it is judged that the expression of the driver is an expression of surprise reaches 10 times in one hour is maintained for 10 hours. As another example, if the threshold value TH is 5 times/10 km, the processing part 26 performs a predetermined processing when the state where the number of times it is judged that the expression of the driver is an expression of surprise reaches 5 times while the vehicle 30 is driving for 10 km is maintained for 100 km.

Further, the processing part 26 may set the threshold value based on the past data of the frequency by which it is judged the expression of the driver is an expression of surprise. In this case, the threshold value is set to a value higher than the past average value of the frequency. For example, the past average value of the frequency is stored in the memory 22 of the ECU 20 etc. When an ignition switch of the vehicle 30 is turned on, the past average value of the frequency is multiplied with a coefficient (for example 2 to 5) to thereby calculate the threshold value. Further, the average value of the frequency in an initial predetermined time (for example 30 minutes) in one trip (time period from when ignition switch of vehicle 30 is turned on until it is turned off) may be multiplied to calculate the threshold value in the subsequent time periods of the trip.

### Second Embodiment

The driver monitoring device according to a second embodiment is basically similar in configuration and control to the driver monitoring device according to the first embodiment except for the points explained below. For this reason, below, the second embodiment of the present disclosure will be explained centered about parts different from the first embodiment.

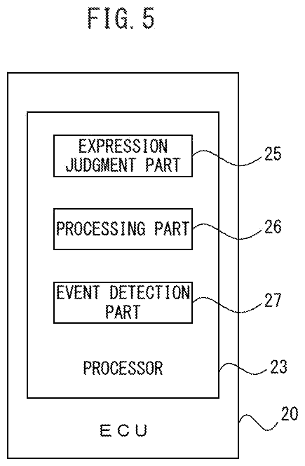

FIG. 5 is a functional block diagram of the processor 23 of the ECU 20 in the second embodiment. In the second embodiment, the processor 23 has an event detection part 27 in addition to the expression judgment part 25 and the processing part 26. The event detection part 27 detects an event showing unsuitable driving by the driver of the vehicle 30. The expression judgment part 25, the processing part 26, and the event detection part 27 are function modules realized by a computer program stored in the memory 22 of the ECU 20 being run by the processor 23 of the ECU 20. Note that, these function modules may respectively be realized by dedicated processing circuits provided at the processor 23.

A driver displays an expression of surprise due to various factors while driving the vehicle 30. An expression of surprise due to driving by a driver is strongly correlated with a decline in cognitive ability of the driver compared with an expression of surprise due to factors other than driving by the driver (for example, conversing with occupants, content of radio, etc.) For this reason, if an expression of surprise by a driver is detected when an event showing unsuitable driving by the driver (below, simply referred to as an “event”) occurs, it is desirable to perform processing for enhancing the safety of the driver at an earlier stage.

Therefore, in the second embodiment, the processing part 26 reduces the threshold value when performing a predetermined processing if it is judged by the expression judgment part 25 that the expression of the driver is an expression of surprise and the event is detected by the event detection part 27. That is, if the event is detected, the predetermined processing is performed in a state with a lower frequency by which it is judged the expression of the driver is an expression of surprise compared with if the event is not detected. Due to this, it is possible to more suitably detect a decline in the cognitive functions of the driver and possible to assist a driver liable to be declining in cognitive functions at a more suitable timing.

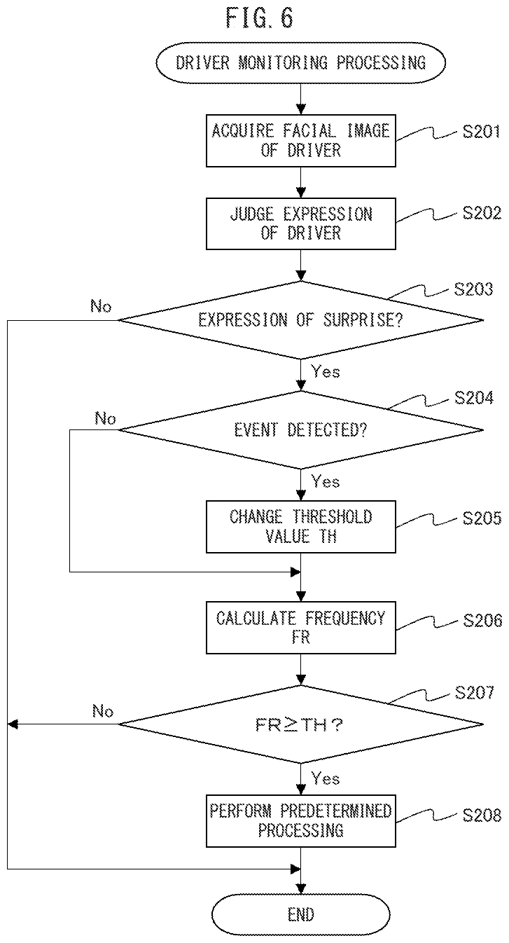

FIG. 6 is a flow chart showing a control routine of driver monitoring processing in the second embodiment of the present disclosure. This control routine is performed repeatedly at predetermined intervals by the processor 23 of the ECU 20 having the expression judgment part 25, the processing part 26, and the event detection part 27.

Steps S201 to S203 are performed in the same way as steps S101 to S103 of FIG. 4. If at step S203 the expression judged by the expression judgment part 25 is judged to be an expression of surprise, the present control proceeds to step S204.

At step S204, the processing part 26 judges whether the event has been detected by the event detection part 27 within a predetermined time period up to the point of time when a facial image of the driver including an expression of surprise is acquired. The event detection part 27 detects a hazardous driving scene, a sudden operation by a driver, etc., as the event. For example, the event detection part 27 detects a hazardous driving scene based on the surrounding environment information of the vehicle 30. Surrounding environment information of the vehicle 30 is detected by the surrounding information detection device 3, and the event detection part 27 acquires surrounding environment information of the vehicle 30 from the surrounding information detection device 3.

Hazardous driving scenes include scenes in which the distance between the vehicle 30 and a moving object around the vehicle 30 (for example, a pedestrian, a surrounding vehicle, a bicycle, etc.) become less than or equal to a predetermined distance. As specific examples of hazardous driving scenes, scenes in which people jump out into intersections, scenes in which people jump out from behind surrounding vehicles, scenes in which the vehicle 30 approaches a rear vehicle at the time of a lane change, etc., may be mentioned. Further, the hazardous driving scenes include the vehicle 30 ignoring signals, bypassing stop signs, etc. Positional information of the traffic signal and stop sign may be obtained from the map database 5.

Further, the event detection part 27 detects sudden operations by the driver (sudden acceleration, sudden deceleration, or sudden steering) based on information on operation of the vehicle 30 by the driver. Information on operation of the vehicle 30 by the driver is detected by the vehicle operation detection device 7. The event detection part 27 acquires the information on operation of the vehicle 30 by the driver from the vehicle operation detection device 7. Sudden acceleration by the driver is detected based on the output of the accelerator position sensor, sudden deceleration by the driver is detected based on the output of the brake position sensor, and sudden steering by the driver is detected based on the output of the steering angle sensor. Note that, the event detection part 27 may detect only one of a hazardous driving scene and a sudden operation by the driver as the event.

If at step S204 it is judged that the event has been detected, the present control proceeds to step S205. At step S205, the event detection part 27 changes the threshold value TH. For example, the event detection part 27 makes the threshold value TH smaller than a predetermined standard value by exactly a predetermined value. On the other hand, if at step S204 it is judged that the event has not been detected, the present control skips step S205 and proceeds to step S206. In this case, a standard value is used as a threshold value TH.

Steps S206 to S208 are performed in the same way as steps S104 to S106 of FIG. 4. After step S208, the present control routine ends. Note that, the control routine of FIG. 6 can be modified in the same way as the control routine of FIG. 4. For example, the standard value of the threshold value may be set based on the past data of the frequency by which it is judged the expression of the driver is an expression of surprise.

Further, the processing part 26 may increase a weight to the frequency by which it is judged the expression of the driver is an expression of surprise when calculating the frequency by which it is judged the expression of the driver is an expression of surprise, if it is judged by the expression judgment part 25 that the expression of the driver is an expression of surprise and the event is detected by the event detection part 27. For example, if the event is not detected when it is judged that the expression of the driver is an expression of surprise, the number of times it is judged that the expression of the driver is an expression of surprise is incremented by 1, while if the event is detected when it is judged that the expression of the driver is an expression of surprise, the number of times it is judged that the expression of the driver is an expression of surprise is incremented by a number larger than 1 (for example 2 to 8).

Further, if a driver frequently displays an expression of surprise when the event occurs, the cognitive ability of the driver is liable to be remarkably declining. For this reason, if it is judged by the expression judgment part 25 that the expression of the driver is an expression of surprise and the frequency by which the event is detected by the event detection part 27 has reached a predetermined value, the processing part 26 may perform another processing with a higher strength of warning than a predetermined processing (below, referred to as “emergency processing”). Due to this, it is possible to suitably assist a driver corresponding to the degree of drop of cognitive ability of the driver.

In this case, for example, the processing part 26 performs, as emergency processing, constant warning, forced stop, request for aid, speed limit (for example, less than or equal to a speed limit prescribed by speed signs), or constant activation of the hazard light. The emergency processing may be lifted on an application running on a mobile terminal (a smart phone, a tablet terminal, etc.) or auto sales outlet by submission of results of a cognitive ability test or driving ability test.

### Other Embodiments

Above, preferred embodiments according to the present disclosure were explained, but the present disclosure is not limited to these embodiments and can be corrected and changed in various ways within the scope of the claims.

For example, a part of the configuration of the vehicle control system 1 shown in FIG. 1 may be omitted. Further, the vehicle 30 may be a vehicle not having a driver assistance function.

Further, a computer program for realizing the functions of the parts of the processor 23 of the ECU 20 or the processor of the server by a computer may be provided in a form stored in a computer readable recording medium. The computer readable recording medium is, for example, a magnetic recording medium, an optical recording medium, or a semiconductor memory.

### REFERENCE SIGNS LIST

2. imaging device
20. electronic control unit (ECU)
23. processor
25. expression judgment part
26. processing part
30. vehicle

1. A driver monitoring device comprising a processor configured to:
judge an expression of a driver of a vehicle from an image generated by an imaging device capturing a face of the driver;
calculate a frequency by which it is judged the expression of the driver is an expression of surprise; and
perform a predetermined processing for enhancing a safety of the driver when the frequency is greater than or equal to a threshold value.

2. The driver monitoring device according to claim 1, wherein the processor is configured to set the threshold value based on past data of the frequency.

3. The driver monitoring device according to claim 1, wherein the processor is configured to detect an event showing unsuitable driving by the driver, and
the processor is configured to reduce the threshold value or increase a weight to the frequency due to it being judged that the expression of the driver is an expression of surprise when calculating the frequency if it is judged that the expression of the driver is an expression of surprise and the event is detected.

4. The driver monitoring device according to claim 3, wherein the processor is configured to detect a hazardous driving scene as the event based on surrounding environment information of the vehicle.

5. The driver monitoring device according to claim 4, wherein the hazardous driving scene includes a scene in which a distance between the vehicle and a moving body around the vehicle is less than or equal to a predetermined distance.

6. The driver monitoring device according to claim 3, wherein the processor is configured to detect a sudden operation by the driver as the event based on information on operation of the vehicle by the driver.

7. The driver monitoring device according to claim 3, wherein the processor is configured to perform another processing with a higher strength of warning than the predetermined processing if it is judged that the expression of the driver is an expression of surprise and the frequency by which the event is detected has reached a predetermined value.

8. The driver monitoring device according to claim 1, wherein the processor is configured to issue a warning to the driver as the predetermined processing.

9. The driver monitoring device according to claim 1, wherein the processor is configured to issue a warning to a person other than the driver as the predetermined processing.

10. The driver monitoring device according to claim 1, wherein the processor is configured to ease a condition for activation of a driver assistance operation in a driver assistance function mounted in the vehicle as the predetermined processing.

11. The driver monitoring device according to claim 1, wherein the processor is configured to fix to a maximum value a set vehicle-to-vehicle distance when adaptive cruise control is actuated in the vehicle as the predetermined processing.

12. A driver monitoring method performed by a computer, comprising:
judging an expression of a driver of a vehicle from an image generated by an imaging device capturing a face of the driver; and
calculating a frequency by which it is judged the expression of the driver is an expression of surprise and performing a predetermined processing for enhancing a safety of the driver when the frequency is greater than or equal to a predetermined threshold value.

13. A non-transitory recording medium having recorded thereon a computer program, the computer program causing a computer to:
judge an expression of a driver of a vehicle from an image generated by an imaging device capturing a face of the driver; and
calculate a frequency by which it is judged the expression of the driver is an expression of surprise and perform a predetermined processing for enhancing a safety of the driver when the frequency is greater than or equal to a predetermined threshold value.
